(19) United States
(12) Patent Application Publication
(10) Pub. No.: US 2025/0047349 A1
(43) Pub. Date: Feb. 6, 2025

(54) METHOD AND APPARATUS FOR CHANNEL STATE INFORMATION PREDICTION AND PERFORMANCE MONITORING AT USER TERMINAL IN WIRELESS COMMUNICATION SYSTEMS

(71) Applicant: Samsung Electronics Co., Ltd., Gyeonggi-do (KR)

(72) Inventors: Ameha Tsegaye ABEBE, Gyeonggi-do (KR); Sripada KADAMBAR, Bangalore (IN); Ashok Kumar Reddy CHAVVA, Bangalore (IN); Youngrok JANG, Gyeonggi-do (KR); Hyoungju JI, Gyeonggi-do (KR)

(21) Appl. No.: 18/794,670

(22) Filed: Aug. 5, 2024

(30) Foreign Application Priority Data
Aug. 3, 2023 (IN) 202311052134

(51) Int. Cl. H04B 7/06; H04W 24/08; H04W 72/1268; H04W 72/51

(52) U.S. Cl. CPC H04B 7/0626; H04W 24/08; H04W 72/1268; H04W 72/51

(57) ABSTRACT

The disclosure relates to a 5G or 6G communication system for supporting a higher data transmission rate. A method performed by a user equipment (UE) in a communication system is provided. The method includes receiving, from a base station via higher layer signaling, a configuration for a channel state information (CSI) report, receiving, from the base station, a monitoring measurement resource, generating the CSI report based on the monitoring measurement resource; and transmitting, to the base station, the CSI report including a monitoring outcome report.

### CROSS-REFERENCE TO RELATED APPLICATION

This application is based on and claims priority under 35 U.S.C. § 119 to Indian Provisional Patent Application No. 202311052134, filed on Aug. 3, 2023, in the Indian Patent Office, the disclosure of which is incorporated herein by reference in its entirety.

### BACKGROUND

### 1. Field

The disclosure relates generally to fifth generation (5G) and beyond 5G communication networks, and more particularly, to monitoring, at the network, CSI prediction performance at the user terminal in a wireless communication network.

### 2. Description of Related Art

To meet the demand for wireless data traffic having increased since deployment of fourth generation (4G) communication systems, efforts have been made to develop an improved 5G or pre-5G communication system, also referred to as a beyond 4G network or a post long term evolution (LTE) system. The 5G communication system is implemented in higher frequency millimeter wave (mmWave) bands, e.g., 60 gigahertz (GHz) bands, to realize higher data rates.

To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like. In the 5G system, hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of IoT technology and the big data processing technology through connection with a cloud server, has emerged. As technology elements, such as sensing technology, wired/wireless communication and network infrastructure, service interface technology, and Security technology have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

Accordingly, various attempts have been made to apply 5G communication systems to IoT networks. For example, technologies such as a sensor network, MTC, and M2M communication may be implemented by beamforming, MIMO, and array antennas. Application of a cloud radio access network (RAN) as the above-described big data processing technology may also be considered as an example of convergence between the 5G technology and the IoT technology.

In 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

As such, there is a need in the art for a method and apparatus introducing configuration from the base station to the user terminal for measurement of CSI for performance monitoring and outcome purposes.

### SUMMARY

The disclosure has been made to address the above-mentioned problems and disadvantages, and to provide at least the advantages described below.

Accordingly, an aspect of the disclosure is to provide methods and an apparatus for a monitoring mechanism at the user terminal to monitor the performance of CSI prediction at the user terminal.

An aspect of the disclosure is to provide methods and systems for the user terminal to report its capability by including information pertaining to CSI measurement and reporting for monitoring purposes.

An aspect of the disclosure is to provide methods and systems for the base station to receive the related capability reports from the user terminal and to configure the terminal with CSI measurement and reporting configurations for monitoring purposes.

An aspect of the disclosure is to provide methods and systems for the user terminal, upon the reception of configuration information from the bases station, to measure and report a monitoring outcome of monitored CSI report(s).

An aspect of the disclosure is to provide methods and systems for the base station to configure multiple candidate CSI report configurations to be monitored and other necessary information for the user terminal to perform monitoring performance of CSI reports.

An aspect of the disclosure is to provide methods and systems for managing the CSI processing units (CPUs) of a user terminal for the measurement and reporting for CSI for monitoring purposes.

An aspect of the disclosure is to provide methods and systems for the user terminal to compress the CSI measured from multiple measurement resources and report to base station accordingly.

In accordance with one aspect of the disclosure, a method performed by a base station in a wireless communication system includes transmitting, to a terminal, configuration information for performing performance monitoring and reporting the monitoring outcome of predictive CSI.

In accordance with an aspect of the disclosure, a method performed by a user terminal in a wireless communication system includes receiving, from a base station, configuration information for performing performance monitoring and reporting the monitoring outcome of predictive CSI.

In accordance with an aspect of the disclosure, a method performed by a user terminal in a wireless communication system includes transmitting, by a terminal, capability information pertaining to measurement and reporting of CSI to monitor the performance of CSI prediction.

In accordance with one aspect of the disclosure, a method performed by a base station in a wireless communication system includes transmitting, to a terminal, information to activate/deactivate/switch/monitor artificial intelligence and machine learning (AIML) functionalities and models.

In accordance with an aspect of the disclosure, a method performed by a user terminal in a wireless communication system includes receiving, from a base station, information to activate/deactivate/switch/monitor AIML functionalities, and models.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network to which the disclosure is applied;

FIG. 2A illustrates a wireless transmit path according to an embodiment;

FIG. 2B illustrates a wireless receive path according to an embodiment;

FIG. 3A illustrates a UE according to an embodiment;

FIG. 3B illustrates a gNB according to an embodiment;

FIG. 4 illustrates a cross-polarized MIMO antenna system according to an embodiment;

FIG. 5 illustrates a layout for a CSI reference signal (CSI-RS) resource mapping in an orthogonal frequency division multiple access (OFDM) time-frequency grid; according to an embodiment;

FIG. 6 illustrates the CSI report configuration and CSI measurement configurations supported in a 5G NR system according to an embodiment;

FIG. 7 illustrates single-sided and two-sided models according to an embodiment;

FIG. 8 illustrates two-sided model-based AI/ML CSI feedback according to an embodiment;

FIG. 9 illustrates a measurement and reporting framework for monitoring predicted CSI according to an embodiment;

FIG. 10 illustrates a method for a measurement and reporting framework for monitoring predicted CSI at the user terminal according to an embodiment;

FIG. 11 illustrates a configuration for a CSI prediction window and CSI monitoring window according to an embodiment;

FIG. 12 illustrates a procedure for aperiodic performance monitoring and monitoring outcome reporting according to an embodiment;

FIG. 13 illustrates a procedure for user terminal-initiated performance monitoring and monitoring outcome reporting for predictive CSI reporting according to an embodiment;

FIG. 14 illustrates a monitoring measurement resource (MMR) configuration according to an embodiment;

FIG. 15 illustrates a performance monitoring outcome reporting of predictive CSI according to an embodiment;

FIG. 16 illustrates two-parts CSI for performance monitoring outcome reporting of predictive CSI according to an embodiment; And

FIG. 17 illustrates user terminal procedure for monitoring multiple candidate CSI reporting configurations according to an embodiment

### DETAILED DESCRIPTION

Hereinafter, embodiments of the disclosure will be described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

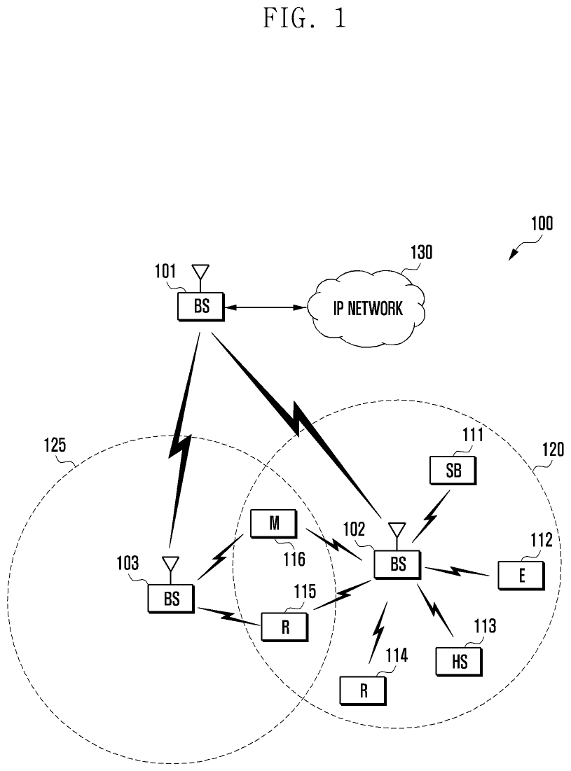

FIG. 1 illustrates a wireless network 100 according to an embodiment.

Referring to FIG. 1, the wireless network 100 includes a gNodeB (gNB) 101, an gNB 102, and an gNB 103. The gNB 101 communicates with the gNB 102 and the gNB 103. The gNB 101 also communicates with at least one Internet protocol (IP) network 130, such as the Internet, a proprietary IP network, or other data network.

Based on the network type, the term gNB can refer to any component or collection of components configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a wireless fidelity (WiFi) access point (AP) and the like. Depending on the network type, other well-known terms may be used instead of user equipment or UE, such as mobile station, subscriber station, remote terminal, wireless terminal, or user device. For the sake of convenience, the terms user equipment and UE are used herein to refer to equipment that wirelessly accesses a gNB and could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance, etc.

The gNB 102 provides wireless broadband access to the network 130 for a first plurality of user equipments (UEs) within a coverage area 120 of the gNB 102. The first plurality of UEs includes a UE which may be located in a small business (SB) 111, a UE which may be located in an enterprise (E) 112, a UE which may be located in a WiFi hotspot (HS) 113, a UE which may be located in a first residence (R) 114, a UE which may be located in a second residence (R) 115, and a UE which may be a mobile device (M) 116, such as a cell phone, a wireless laptop, a wireless PDA, or the like. The gNB 103 provides wireless broadband access to the network 130 for a second plurality of UEs within a coverage area 125 of the gNB 103. The second plurality of UEs are located at the R 115 and the M 116. One or more of the gNBs 101-103 may communicate with each other and with the UEs at locations 111-116 using 5G, long-term evolution (LTE), LTE-A, WiMAX, or other advanced wireless communication techniques.

Dotted lines show the approximate extents of the coverage areas 120 and 125, which are shown as approximately circular for illustration purposes only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include two-dimensional (2D) antenna arrays and support the codebook design and structure for systems having 2D antenna arrays.

Although FIG. 1 illustrates one example of a wireless network 100, various changes may be made such that the wireless network 100 can include any number of gNBs and any number of UEs in any suitable arrangement. The gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

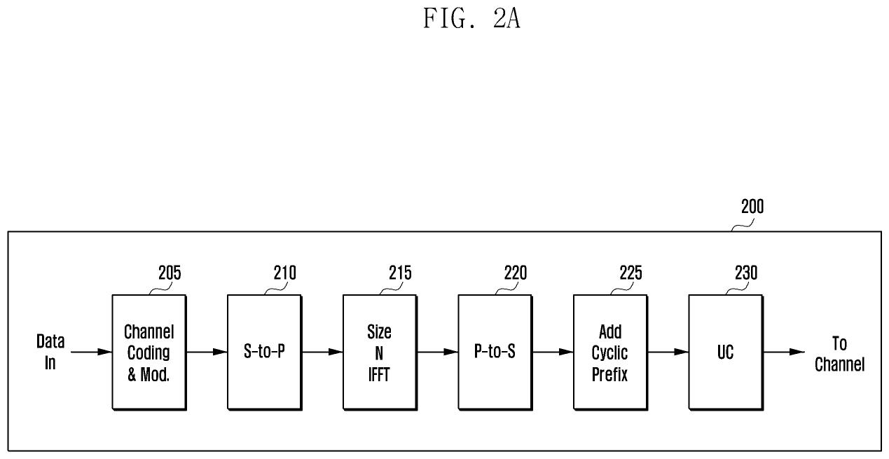

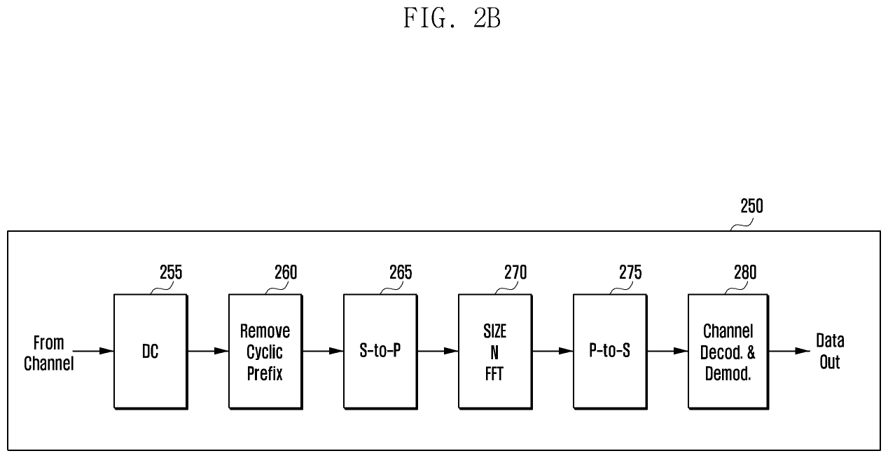

FIG. 2A illustrates a wireless transmit path according to an embodiment. FIG. 2B illustrates a wireless receive path according to an embodiment.

Referring to FIG. 2A, a transmit path 200 may be described as being implemented in an gNB. Referring to FIG. 2B, a receive path 250 may be described as being implemented in a UE. However, it will be understood that the receive path 250 can be implemented in an gNB and that the transmit path 200 can be implemented in a UE. The receive path 250 is configured to support the codebook design and structure for systems having 2D antenna arrays as described in embodiments of the disclosure.

In FIG. 2A, the transmit path 200 includes a channel coding and modulation block 205, a serial-to-parallel (S-to-P) block 210, a size N inverse fast Fourier transform (IFFT) block 215, a parallel-to-serial (P-to-S) block 220, an add cyclic prefix block 225, and an up-converter (UC) 230. In FIG. 2B, the receive path 250 includes a down-converter (DC) 255, a remove cyclic prefix block 260, a serial-to-parallel (S-to-P) block 265, a size N fast Fourier transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 210 de-multiplexes the serial modulated symbols to parallel data to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 multiplexes the parallel time-domain output symbols from the size N IFFT block 215 to generate a serial time-domain signal. The add cyclic prefix block 225 inserts a cyclic prefix to the time-domain signal. The up-converter 230 up-converts the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs at locations 111-116 and may implement a receive path 250 that is analogous to receiving in the uplink from UEs at locations 111-116. Similarly, each of UEs at locations 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Although described as using FFT and IFFT, this is by way of illustration only and should not be construed to limit the scope of this disclosure. Other types of transforms, such as discrete Fourier transform (DFT) and Inverse DFT (IDFT) functions, can be used. The value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various components can be combined, further subdivided, or omitted and additional components can be added according to particular needs. Also, FIGS. 2A and 2B illustrate examples of the types of transmit and receive paths that can be used in a wireless network. Any other suitable architectures can be used to support wireless communications in a wireless network.

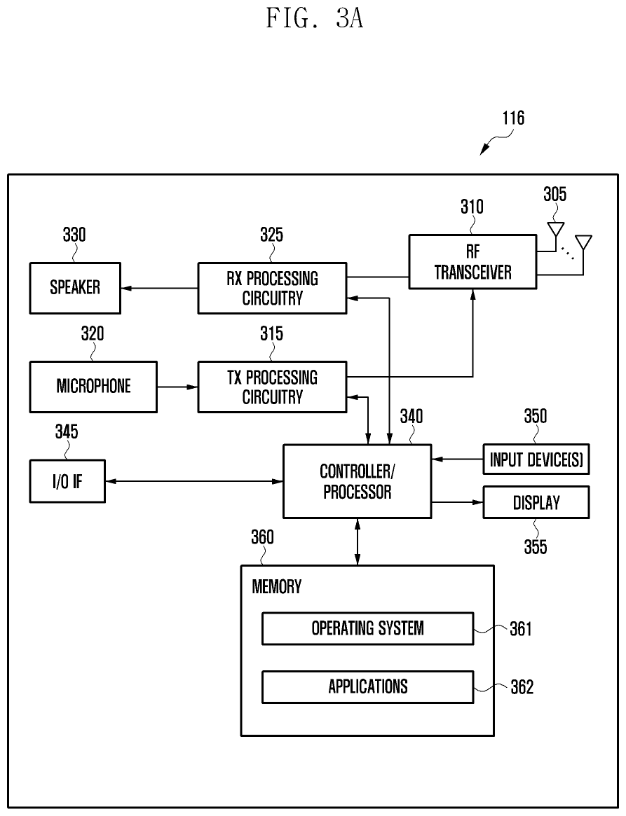

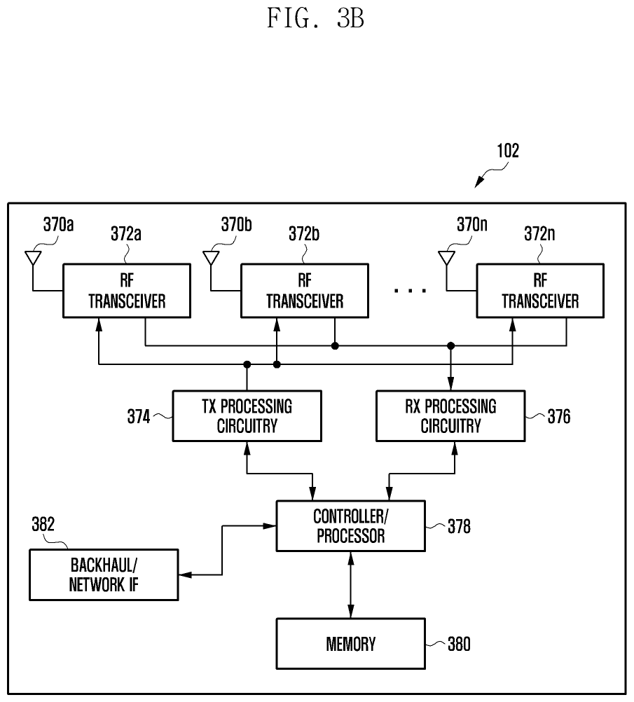

FIG. 3A illustrates an example UE 116 according to an embodiment.

Referring to FIG. 3A, the UE 116 includes an antenna 305, a radio frequency (RF) transceiver 310, transmit (TX) processing circuitry 315, a microphone 320, receive (RX) processing circuitry 325, a speaker 330, a main processor 340, an input/output (I/O) interface (IF) 345, a keypad 350, a display 355, and a memory 360 including a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal sent to the RX processing circuitry 325, which generates a processed baseband signal by filtering, decoding, and/or digitizing the baseband or IF signal. The RX processing circuitry 325 transmits the processed baseband signal to the speaker 330, such as for voice data, or to the main processor 340 for further processing, such as for web browsing data.

The TX processing circuitry 315 receives analog or digital voice data from the microphone 320 or other outgoing baseband data, such as web data, e-mail, or interactive video game data, from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. The main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 can move data into or out of the memory 360 as required by an executing process. The main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display (LCD) or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various components can be combined, further subdivided, or omitted and additional components can be added according to particular needs. For example, the main processor 340 can be divided into multiple processors, such as one or more central processing units (CPUs) and one or more graphics processing units (GPUs). Also, while the UE 116 is shown as being configured as a mobile telephone or smartphone, UEs can be configured to operate as other types of mobile or stationary devices.

FIG. 3B illustrates a gNB 102 according to an embodiment. The embodiment of the gNB 102 shown in FIG. 3B is for illustration only, and other gNBs of FIG. 1 can have the same or similar configuration.

Referring to FIG. 3B, the gNB 102 includes multiple antennas 370a-370n, multiple RF transceivers 372a-372n, transmit (TX) processing circuitry 374, and receive (RX) processing circuitry 376. One or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378 and encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform a blind interference sensing (BIS) process, such as performed by a BIS algorithm, and decodes the received signal subtracted by the interfering signals. Any of a wide variety of other functions can be supported in the gNB 102 by the controller/processor 378. The controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described herein. The controller/processor 378 supports communications between entities, such as web real-time communications (RTC). The controller/processor 378 can move data into or out of the memory 380 as required by an executing process.

The controller/processor 378 is also coupled to the backhaul or network interface 382 which enables the gNB 102 to communicate with other devices or systems over a backhaul connection or over a network. The backhaul or network interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. A plurality of instructions, such as a BIS algorithm is stored in memory. The plurality of instructions is configured to cause the controller/processor 378 to perform the BIS process and to decode a received signal after subtracting out at least one interfering signal determined by the BIS algorithm.

The transmit and receive paths of the gNB 102 (implemented using the RF transceivers 372a-372n, TX processing circuitry 374, and/or RX processing circuitry 376) support communication with aggregation of frequency division duplex (FDD) cells and time division duplex (TDD) cells.

Although FIG. 3B illustrates one example of a gNB 102, various changes may be made, and the gNB 102 can include any number of each component shown in FIG. 3. For example, an access point can include a number of interfaces 382, and the controller/processor 378 can support routing functions to route data between different network addresses. While shown as including a single instance of TX processing circuitry 374 and a single instance of RX processing circuitry 376, the gNB 102 can include multiple instances of each (such as one per RF transceiver).

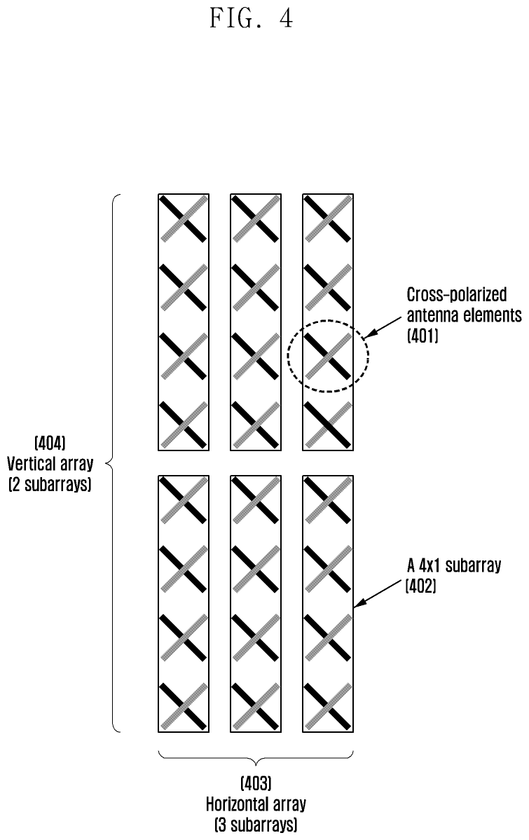

Referring to FIG. 4, an example of MIMO antenna configuration with 24 antenna elements is shown. Four (4) cross-polarized 401 antenna elements form a 4×1 subarray 402. 12 subarrays form a 2V3H MIMO antennas configuration consisting of 2 and 3 subarrays in vertical 404 and horizontal 403 dimensions, respectively. Although FIG. 4 illustrates one example of MIMO antenna configuration, the disclosure can be applied to various such configurations.

In MIMO systems, the CSI is required at the BS so that a signal from the BS is received at the UE with maximum possible received power and minimum possible interference. The acquisition of CSI at the BS can be via a measurement at the BS from a UL reference signal or via a measurement and feedback by the UE from a DL reference signal for TDD and FDD systems, respectively. In 5G FDD systems, the CSI-RS is the primary reference signal that is used by the UE to measure and report CSI.

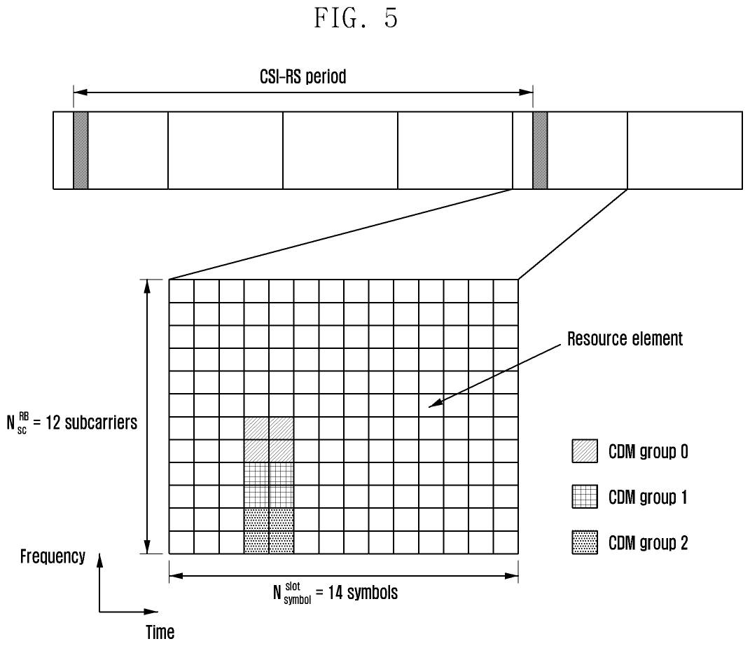

FIG. 5 illustrates a layout for a CSI-RS resource mapping in an OFDM time-frequency grid, according to an embodiment. Referring to FIG. 5, a UE may receive a configuration signaling from a BS for a CSI-RS that can be used for channel measurement. Antenna ports (CSI-RS ports) are mapped to a CSI-RS with code-domain multiplexing (CDM) group 0, group 1 and group 2, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations, namely: periodic, semi-persistent and aperiodic are possible. In the figure, an illustrative example of periodic configuration is given with a period of 4 slots.

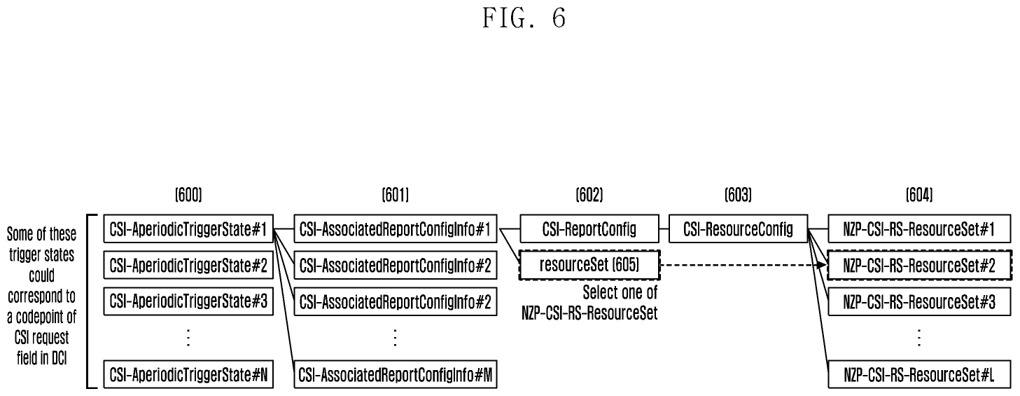

FIG. 6 illustrates the CSI report configuration and CSI measurement configurations supported in a 5G NR system according to an embodiment. Referring to FIG. 6, a UE can be configured to measure CSI feedback with a CSI report configuration. A CSI report configuration can be periodic, semi-persistent or aperiodic manner. FIG. 6 depicts the CSI report configuration and CSI measurement configurations that is supported in a 5G NR system. A CSI report configuration (602) can be linked to a CSI resource configuration (603). The CSI resource configuration (602) may contain one or more CSI resource sets (604) for channel measurement (CMR) or inference measurement (IMR).

In periodic (P) and semi-persistent (SP) CSI report setting, the CSI resource configuration contains a single CSI resource set. In case of aperiodic (AP) CSI report, a UE can be configured with multiple CSI report triggering states (600). A CSI report triggering state may contain one or more CSI associated report configuration information (601). A downlink control information (DCI) may include a CSI request which indicates one of the configured triggering states. The DCI with CSI request may also contain a resource set selection field (605) to select one of the resources sets (604).

Moreover, a CSI report can be configured with one of the CSI reporting quantities including a CSI resource indicator (CRI), the rank indicator (RI), precoding matrix indicator (PMI), channel quality indicator (CQI), layer indicator (LI), signal to interference and noise ratio (SINR), and reference signal receive power (RSRP). In 5G NR, various CSI reporting quantiles are adopted. An RRC parameter reportQuantity set to either ‘none’, ‘cri-RI-PMI-CQI’, ‘cri-RI-il’, ‘cri-RI-il-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’.

The CSI reporting can be used for transmission beam management (BM), specifically, in higher frequency bands, e.g., in frequency range 2 (FR2). In this case, the gNB may configure the UE to report one of the following quantities including, ‘cri-RSRP’, ‘cri-SINR’, ‘ssb-Index-RSRP’, ‘ssb-Index-SINR’, ‘cri-RSRP-Index’, ‘ssb-Index-RSRP-Index’, ‘cri-SINR-Index’ or ‘ssb-Index-SINR-Index’.

The CSI report can be used for the downlink transmission CSI including ‘cri-RI-PMI-CQI’, ‘cri-RI-il’, ‘cri-RI-il-CQI’, ‘cri-RI-CQI’.

Recently, data-driven algorithms, also known as AI or machine-learning (AI/ML), have gained considerable attention. Main application areas include solving non-linear optimization problems that cannot be directly solved by convention solutions. Use cases that have recently been highlighted include CSI compression, CSI prediction, beam prediction, positioning, channel estimation and interpolation, MU-MIMO scheduling, etc.

Herein, any data-driven algorithm and its parts are referred to as an AI/ML model.

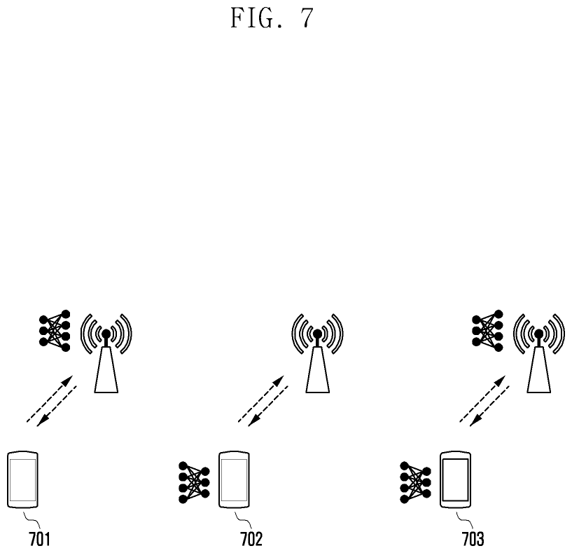

FIG. 7 illustrates single-sided and two-sided models according to an embodiment.

Referring to FIG. 7, such an AI/ML model can be located at the UE (701), network (702) or at both UE and network (703). An AI/ML model may require to be trained with a training dataset before it is used for inference (to produce a set of prediction output from set of inputs). When the AI/ML model inference is performed in one node, i.e., UE or network node, the model is referred to as single-sided model, UE-sided model or network-sided model. When the inference is jointly made at two nodes, i.e., the first part of the inference at UE and the second part at the network, the AI/ML model is referred to as a two-sided model.

One use case of AI is AI/ML based CSI feedback.

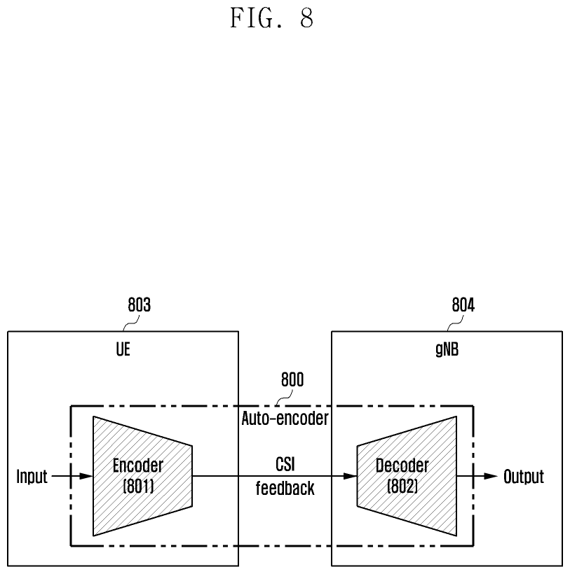

FIG. 8 illustrates two-sided model-based AI/ML CSI feedback according to an embodiment.

Referring to FIG. 8, an auto-encoder (AE), which is a two-sided model as illustrated, consists of an encoder part (801) at the UE 803 which generates the CSI feedback and a decoder (802) at the gNB 804 which reconstructs the CSI feedback. An AE-based CSI feedback aims to find the best representation of a channel state information in terms of feedback overhead. In other words, AE compresses the CSI to reduce the CSI feedback overhead.

When at least one of the transmitter (base station), the receiver (UE) or even the surrounding environment are mobile, the reported channel state information may become stale before it is applied for the downlink data transmission, which is widely known as CSI aging. In this case, the UE may have to measure and report the CSI more frequently. However, frequent feedback implies higher measurement and reporting overhead which thus degrades system performance. Moreover, due to the CSI processing time to derive the reported CSI, in some cases, merely allowing the UE to report CSI frequently does not solve the channel aging problem. In another words, no matter how frequently the UE reports CSI, the reported CSI could be aged (stale) degrading performance.

In the aforementioned scenarios and others, it may be beneficial if either the terminal or the base station predicts CSI. In particular, the terminal may first predict and then report the CSI for future application times (downlink data transmission). Upon the reception of the predicted CSI, the base station then applies to the transmission of downlink data at the appropriate time. Such CSI prediction can be performed based on AI/ML models.

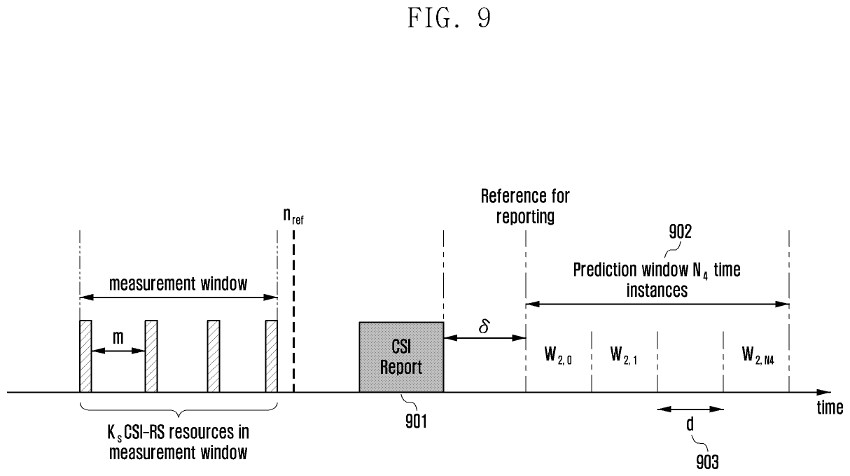

FIG. 9 illustrated a configuration wherein a UE predicts CSI by measuring Ks CSI-RS resources in a measurement window, according to an embodiment.

Referring to FIG. 9, the predicted CSI reported by utilizing uplink resource (901) can be applied to N4 prediction instances in a prediction window (902). Each prediction instance in the prediction window which spans d slots 903 is associated to precoder information (precoding vectors) reported by the UE. Thus, the base station can utilize this precoding information to precoder the downlink transmission of PDSCH in the respective application time.

However, the performance of such CSI prediction could be affected by various aspects. As an example, the CSI prediction method including the AI/ML model applied by the terminal may only be applicable to a certain set of applicable scenarios and configurations, such as the UE's speed, as shown below in Table 1. In particular, the AI/ML models are trained by a dataset collected from a certain set of scenarios and configurations. The AI/ML model for CSI prediction could be trained based on a training dataset associated with certain UE speed or certain range of UE speeds. In this case, if the same model is applied to predict a CSI for a UE with a different speed outside of the range of UE speeds considered for training dataset generation, the CSI prediction performance degrades. Additionally, if the AI/ML model is trained based on a dataset from a large range of UE speeds, then the performance may degrade as compared to CSI prediction based on AI/ML models trained with dataset from narrower range UE speeds. Thus, it may be beneficial for the UE to maintain multiple AI/ML models each applicable to a narrower range of scenarios, e.g., UE speeds. Then, the UE may switch through these AI/ML models based on the current situation. Another action that can be performed is to fallback to a non-prediction mode. To take such actions properly, however, a mechanism for active monitoring the environment and the performance of AI/ML models.

TABLE 1
Prediction - UE velocity generalization | % SGCS gains

| | | Test | | | | | |
|---|---|---|---|---|---|---|---|
| | | 10 | 20 | 30 | 40 | 60 | 120 |
| Train | | kmph | kmph | kmph | kmph | kmph | kmph |
| 10 | kmph | 8.8% | 8.0% | 1.5% | 11.4% | 7.4% | −2.1% |
| 20 | kmph | −11.6% | 14.3% | 5.0% | 10.6% | 16.7% | −1.1% |
| 30 | kmph | −27.2% | 1.6% | 11.9% | 15.9% | 25.2% | 0.3% |
| 40 | kmph | −36.1% | −14.1% | 1.4% | 21.3% | 24.8% | 0.9% |
| 60 | kmph | −51.2% | −29.2% | −19.5% | −5.6% | 31.6% | 8.9% |
| 120 | kmph | −58.3% | −44.2% | −39.9% | −29.2% | −3.4% | 25.3% |

Herein, the terms AI/ML model, model AI model are used interchangeably to refer to a data-driven algorithm that takes a certain set of inputs and produces a certain set of outputs. An AI/ML model may require to be trained with a training dataset before it is used for inference to produce a set of prediction output from set of inputs.

An AI/ML model can be neural network (NN)-based which is composed of many interconnected neurons described by parameters which may consist of weights and biases. The interconnection between neural networks may have structure, such as assortments of neurons into multiple layers. If the number of layers in AI/ML model is relatively large, the model can be referred to as a deep neural network (DNN). Then, the layers could be interconnected with dense or sparse connections.

An AI/ML model can take various backbone structures, e.g., dense neural networks (DNN) convolutional neural network (CNN), long-short term memory (LSTM), transformer (TF), etc.

An AI/ML model can be scenario-specific or configuration-specific by providing the desired performance only in a set of scenarios or set of configurations. These models are typically trained by a dataset collected from a certain set of scenarios and configurations. For example, an AI/ML CSI compression model may perform as desired only when it is applied to a set of CSI antenna port configurations or CSI payload size configurations. Alternatively, an AI/ML-based CSI compression model may work only under certain set of scenarios, e.g., UE speed.

The UE or network may have to keep multiple scenario/configurations specific AI/ML models for different sets of scenarios or configurations. Thus, when a certain set of configurations is applied or a certain scenarios is detected, the UE or network may select the appropriate model.

The UE or network may have to activate the appropriate AI/ML model for inference. This activation process may require the UE or network to load the model to the processing unit, e.g., a CPU, a graphical processing unit (GPU), a neural processing unit (NPU), etc.

The UE or network may have to deactivate an AI/ML model. This deactivation process may include unloading the model from the processing unit (freeing up the processing unit).

The UE or network may have to switch through AI/ML models depending on the scenarios and configurations. The switching process may include deactivation, selection and activation of AI/ML models.

The UE or network may have to update AI/ML models based dataset for a set of scenarios and configurations. The model update process may include at least updating the model parameters based on a training dataset.

The UE or network may have to collect training dataset for given scenarios or configurations. The training data collected can then be applied to train a new model or update an existing one.

The UE or network may have to monitor the performance of the AI/ML model. The model monitoring process may include comparison of the output from AI/ML model to the ground truth. In some cases, one node measures the ground truth and one node makes AI/ML model inference. In such cases, it may be necessary to exchange monitoring dataset, e.g., ground truth, AI/ML model inference output, from one node to the other.

A network node or a UE may train a model and transfer to the other node. The model can be compiled for execution before or after the model transfer, which may be beneficial as it allows to train the model in the environment where it will be used (for inference).

The process of managing the different aspects mentioned above, such as data collection, model training, model selection, model activation, model inference, model deactivation, model switching, model updating, and model monitoring, can be referred as model life cycle management (LCM).

A node can give assistance or control the LCM of a model in another node. For example, the network may assist/control a model in the UE side for UE-side or UE part of two-sided model.

The network may provide LCM assistance to the UE by being specific to a particular model. Thus, the network may be required to identify the model on the UE side unambiguously. For this purpose, a model ID for model LCM can be used and is referred to as model-ID based LCM.

The performance of AI/ML-based CSI prediction is performed at the base station. A consideration for executing performance monitoring is for the base station to compare the predicted CSI and the ground truth CSI. In this case, the base station may get access to the ground truth CSI through the UE's report or through some form of uplink measurement.

The execution of AI/ML-based CSI prediction may also be performed at the UE. A consideration for executing performance monitoring is for the UE is to compare the predicted CSI and the ground truth CSI. In this case the UE may get access to the ground truth CSI through indirect or a dedicated measurement.

### CSI Report Configuration

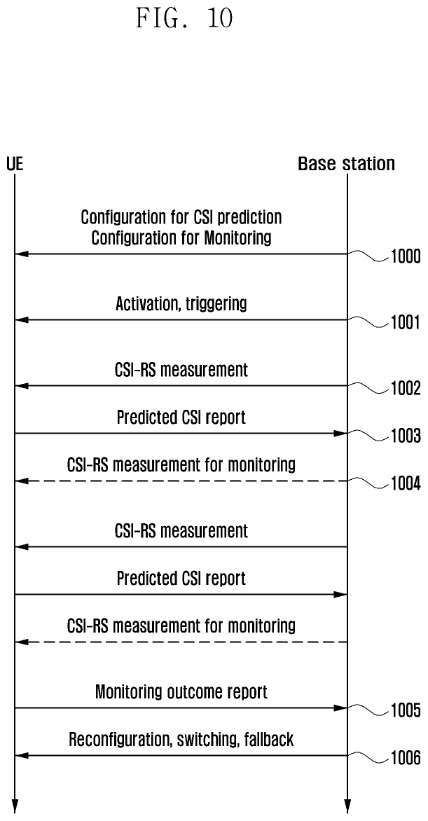

FIG. 10 illustrates a method for a measurement and reporting framework for monitoring predicted CSI at the user terminal according to an embodiment.

Referring to FIG. 10, the base station configures a measurement and reporting method for CSI prediction and the corresponding report for monitoring (1000). In semi-persistent and aperiodic CSI reporting, the configuration in (1000) could be activated or triggered by an additional message (1001) from the bases station. Such an additional message could be transmitted via medium access control-control element (MAC-CE) or DCI.

Upon the reception of such configuration and optionally additional activating or triggering messages, the UE may report the corresponding predicted CSI (1003) and perform performance monitoring reporting (1005). For this purpose, the UE may receive CSI-RS resources for measurement of predicted CSI (1002) and for monitoring purposes (1004). Based on the received monitoring outcome, the base station may reconfigure the CSI-RS measurement and reporting. The base station may also switch the configured predictive-based CSI or fallback to a non-predictive CSI report (1006).

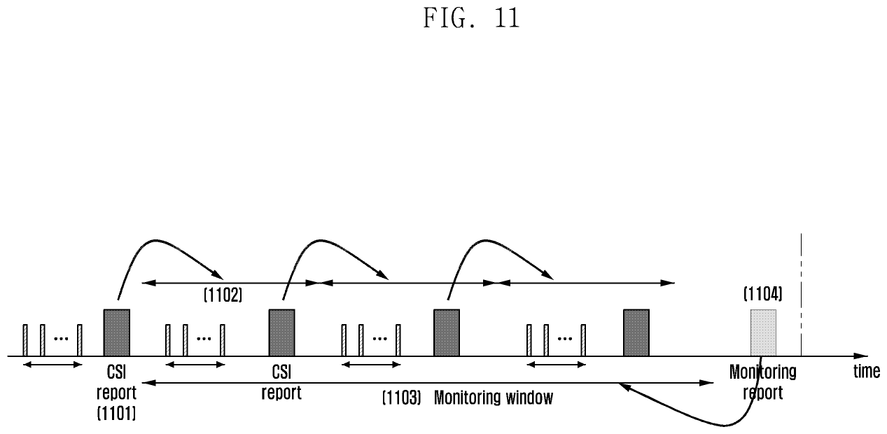

FIG. 11 illustrates a configuration for a CSI prediction window and CSI monitoring window according to an embodiment.

Referring to FIG. 11, such configuration for periodic reporting of the CSI report (1101) and monitoring outcome reports (1104) is illustrated. In this case, if the predicted CSI report and the monitoring outcome report are configured together, they can be configured to have different periodicity. The configuration for predicted CSI may contain information related to a prediction window (1102) that corresponds to the time duration for the predicted CSI to be applied. Similarly, the configuration for monitoring outcome reporting may contain information related to a monitoring window (1103) that corresponds to the time duration for the UE to perform monitoring.

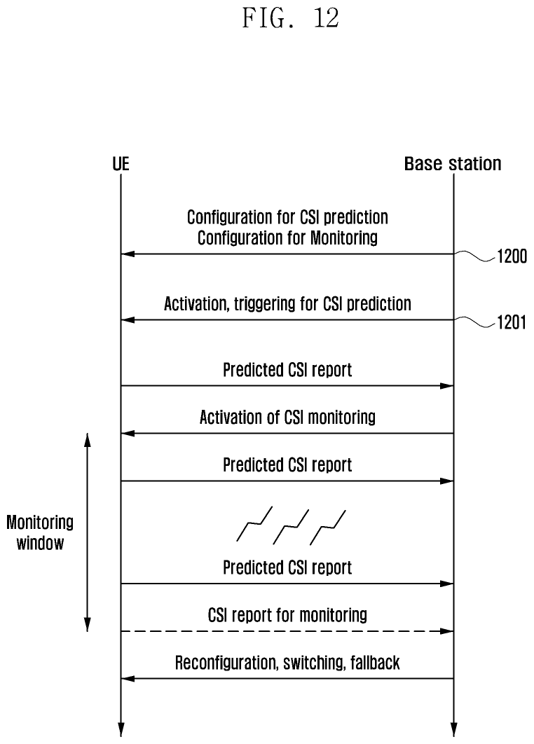

FIG. 12 illustrates a procedure for aperiodic performance monitoring and monitoring outcome reporting according to an embodiment.

Referring to FIG. 12, a case wherein the base station configures the UE with CSI prediction and the monitoring for predictive CSI (1200) is illustrated. Such configuration may help to link the CSI monitoring configuration and the CSI report configuration. However, the UE may be expected to monitor the performance of its reported predictive CSI only after it receives the activation/triggering message for monitoring. The monitoring activation message could be separately provided to the UE by the base station from the activation/triggering message for CSI report (1201).

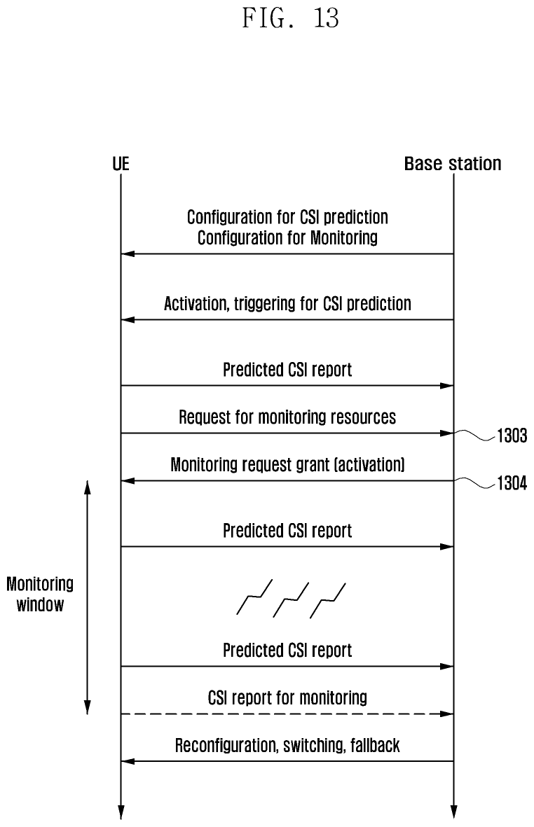

FIG. 13 illustrates a procedure for user terminal-initiated performance monitoring and monitoring outcome reporting for predictive CSI reporting according to an embodiment.

Referring to FIG. 13, the UE may initiate the predictive CSI monitoring. For this, the UE may request (1303) the assignment or activation of monitoring measurement resources and monitoring reports. The base station then may grant (1304) the request by transmitting measurement resources and scheduling uplink resources for monitoring outcome reporting. Upon reception of such monitoring resources grant, the UE may measure the corresponding CSI-RS resources and monitor the performance of its predictive CSI. The base station may use separate activation/triggering messages for activating/triggering measurement for monitoring and resource for monitoring outcome reporting. Therefore, step (1304) can be divided in to two steps, one for activation/triggering of measurement resources and one for activation/triggering of resources for monitoring outcome reporting.

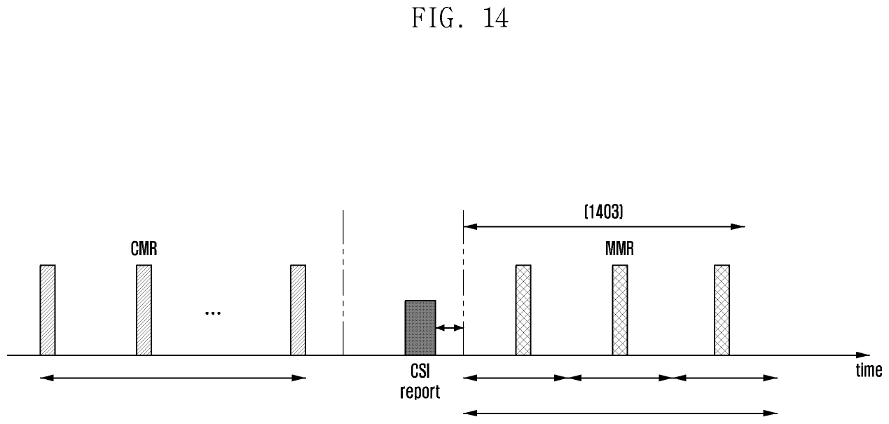

FIG. 14 illustrates an MMR configuration according to an embodiment.

Referring to FIG. 14, a method is provided in which the base station configures CSI measurement resources for monitoring purposes, also referred to as MMRs. An MMR (1403) could be a non-zero power CSI-RS (NZP-CSI-RS) resource or a synchronization signal block (SSB) resource. The CSI monitoring measurement resource is measured within the prediction window. As indicated in FIG. 14, the MMRs can be configured to be measured in time instances corresponding to the application of the predicted CSI.

### Baseline and Performance Metric Configuration for Monitoring

It is beneficial for the mechanism to compare the predicted CSI and the target CSI reported for monitoring purposes provided to the UE as part of configuration for monitoring. For example, the target key performance indicator, the sensitivity of the monitoring mechanism and other parameters could be configured by the base station to the UE.

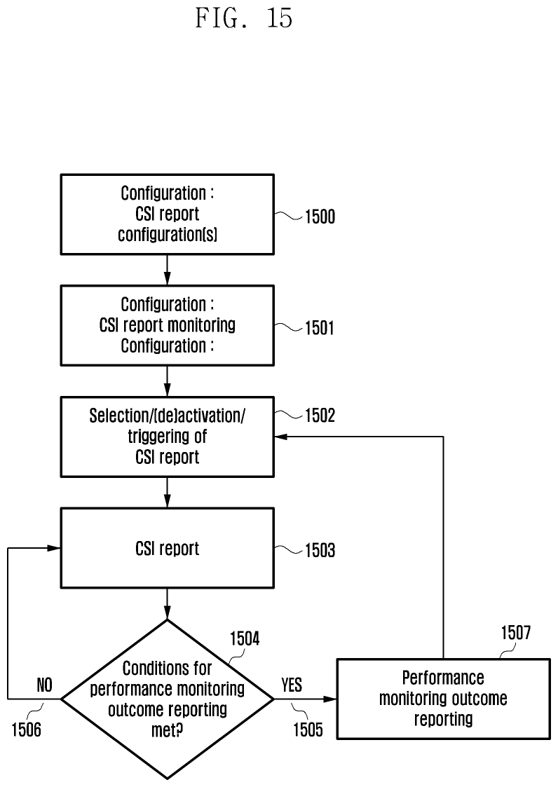

FIG. FIG. 15 illustrates a performance monitoring outcome reporting of predictive CSI according to an embodiment.

Referring to FIG. 15, the base station configures the UE with CSI report configurations (1500) and CSI report monitoring configurations (1501). The configuration information in (1500) and (1501) could be provided to the UE by the base station in the same or different higher layer information element. Among the configured CSI reporting configurations, the base station may select, activate, deactivate or trigger CSI report configurations (1502). By following the activation, triggering message (1502), the UE may transmit the CSI report (1503) to the base station. Based on the CSI monitoring configuration information provided by the base station, the UE may monitor the performance of its CSI reports. If the conditions (1504) set for performance monitoring outcome reporting are met (1505), the UE may report the monitoring outcome to the base station (1507). If not (1506), the UE may continue the process the CSI report (1503). Based on the performance monitoring outcome report from the UE in (1507), the base station then may select, (de) activate, trigger the CSI report.

Herein, the base station configures the UE with information pertaining to the baseline CSI to monitor the predicted CSI as part of the configuration for CSI report monitoring. This information may include A codebook configuration to derive the baseline CSI to which the UE compares its predicted CSI. In the disclosure, such configuration could be given to the UE by a higher layer information element.

The base station may also configure the UE with information pertaining to performance measurement metric to monitor the predicted CSI as part of the configuration for CSI report monitoring. This information may include a metric to derive a performance measurement to compare the baseline CSI and the predicted CSI. Such a configuration could be given to the UE by a higher layer information element. Examples of metrics that could be configured include squared generalized cosine similarity (SGCS), normalized mean squared error (NMSE), and cordial distance.

The UE may also receive conditions for reporting the performance monitoring outcome. The base station may configure the UE with the conditions, e.g., via a higher layer parameter. A UE may also apply a predefined set of conditions known by both the UE and base station. The conditions for monitoring outcome reporting could include for example, the number of monitoring occasions before reporting, the number of monitoring occasions with monitoring performance below a threshold, or the number of monitoring occasions with monitoring performance of deactivated CSI report is better than the activated CSI report but are not limited thereto.

Herein, if the UE is configured with the number of monitoring occasions for which the monitoring performance is below a threshold as a condition to report monitoring outcome, the UE counts the CSI reporting occasions for which the performance is below a threshold. When such count is greater than or equal to the configured number, the UE reports the CSI monitoring outcome accordingly.

### Monitoring Over Inactive Functionalities and AIML Models

The following provides mechanisms to monitor inactive functionalities and AIML models. In some cases, the base station may want the UE to select the appropriate CSI reporting configuration according to the existing observed scenario. Thus, the base station may configure the UE with multiple CSI reporting configurations for the UE to monitor.

For example, the base station configures the UE with information related to a list of candidate CSI report configurations for the UE to consider while performing monitoring. Upon receiving such configuration from the base station, the UE executes the performance monitoring on these CSI reporting configurations.

Alternatively, based on the additional configuration information provided from the base station on the conditions to report a monitoring outcome, the UE reports the monitoring outcome.

One monitoring outcome could be a suggestion by the UE on the suitable CSI report configuration(s) among the CSI report configurations configured as candidate CSI report configurations for monitoring.

Alternatively, based on the additional configuration information provided from the base station on the conditions for the UE to select and report CSI, the UE may report CSI by selecting one of the candidate CSI report configurations. In this case, the UE may not need to report the monitoring outcome but makes the selection of CSI reporting configurations based on its observation on performance of candidate CSI reporting configurations.

### Report Quantity and UCI Structure

The CSI report monitoring outcome can be reported by the UE together with the associated CSI report or separately as a standalone CSI report quantity.

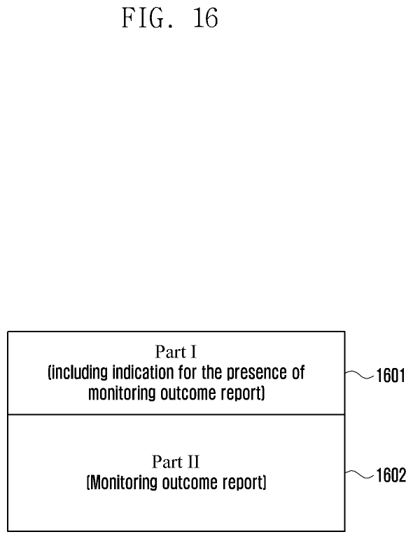

FIG. 16 illustrates two-parts CSI for performance monitoring outcome reporting of predictive CSI according to an embodiment.

Referring to FIG. 16, in accordance with the configuration from the base station and when the conditions to report the monitoring outcome are met, the UE may report the CSI report monitoring outcome in the associated CSI report. As this monitoring outcome reporting is conditioned on the observed scenario, it may be beneficial for the UE to additionally indicate the presence of this monitoring outcome report in its CSI report to enable the base station to easily decode the UCI as the size of the report could be inferred based on Part I (1601) of the CSI report. Specifically, the UE may report the indication of the presence of the monitoring outcome report in Part I (1601) of the CSI report, based on a single bit which indicates the presence and conversely absence of the monitoring outcome report in Part II (1602) of the CSI report. There could also be a more detailed indication which indicates information on the bitwidth (payload size) of the monitoring outcome reporting. Additionally, Part II CSI may include the CSI monitoring outcome.

Alternatively, based on the configuration from the base station and when the conditions to report the monitoring outcome are met, the UE may report the CSI report monitoring outcome separately as a standalone quantity. In this case, a separate triggering message for monitoring outcome reporting is needed. Upon reception of such message, the UE may report the monitoring outcome. If additional conditions for monitoring outcome reporting are also configured but the conditions are not met, the UE may indicate the absence of the monitoring outcome reporting, e.g., via a single bit. Thus, if the UE indicates the presence of monitoring outcome reporting, the base station may decode the information accordingly.

As one embodiment of the disclosure, the CSI reporting quantity could be based on following Equation (1):

$${outcome}_{monitoring} = \frac{1}{{N}_{occasions}} {\sum }_{occasions} f ( {CSI}_{monitored} , {CSI}_{measured} ) \qquad ( 1 )$$

In Equation (1), f(CSI_{monitored}, CSI_{measured}) is calculated by averaging over N_{occasions} CSI reporting occasions by comparing the monitored CSI and measured CSI denoted by CSI_{monitored} and CSI_{measured}, respectively. The monitoring KPI f(.) could be configured to the UE as part of configuration for monitoring or predefined and known by both the UE and base station. Such KPIs include SGCS, NMSE, RAR and chordal distance. The number of occasions to calculate the monitoring outcome could be predefined and known by both the UE and the base station or provided to the UE as part of the configuration for monitoring.

The monitoring outcome in Equation (1) could be quantized before reporting based on predefined rule and possibly with base station's configuration.

When a UE monitors multiple candidate CSI report configurations, the monitoring outcome in Equation (1) could be calculated for multiple CSI reports. In this case, each candidate reporting configuration can be considered as a monitored CSI. The UE may also be configured to report multiple monitoring outcomes for a subset of the candidate reporting configurations, which enables the base station to select and activate one of the best performing candidate CSI configurations.

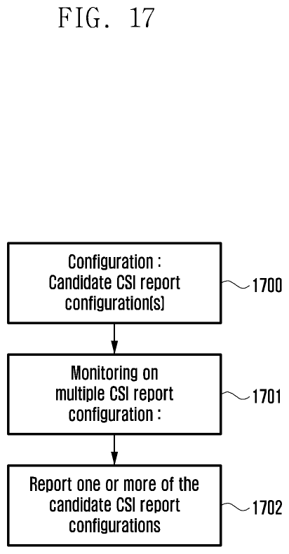

FIG. 17 illustrates user terminal procedure for monitoring multiple candidate CSI reporting configurations according to an embodiment.

Referring to FIG. 17, to select the preferred CSI report configurations from CSI report configurations (1700), the UE may perform monitoring outcome calculation, e.g., in accordance with Equation (1), and compare the monitored candidate CSI report configurations (1701). Then, the UE may indicate one or more of the best performing candidate CSI report configurations to the base station (1702).

For example, for N_{candidate CSI} candidate CSI report configurations, the base station may configure the UE to report N_{preferred CSI} best performing CSI report configurations. Then a UE indicate these configurations in UL UCI with bitwidth [log₂(N_{candidate CSI}/N_{preferred CSI}].

The UE may also dynamically select the number of preferred CSI to be reported. N_{preferred CSI} to be reported and report the preferred CSI in the preferred CSI report.

### Capability Report

Various models of UE may have different capabilities pertaining to the disclosed methods and systems above. For example, a UE may have limited capability on the number of channel measurements the UE can perform within a certain time duration. A UE may have limited capability in terms of memory/storage on the maximum duration in which the UE can buffer the measurements.

As described above, the UE reports its capability on the maximum number of CSI-RS resources for monitoring MMRs, and the maximum number of ports per resource or the total number of ports across MMRs. Upon reception of such capability report, the base station configures the UE with measurement and reporting configuration within the capability of the reported capability report.

Herein, the UE reports its capability on the maximum duration for measurement for CSI-RS resources for monitoring. The capability report may be reported in time units. A time unit may be a transmission slot. If the UE reports X slots as its capability report, the UE does not expect to be configured to measure CSI for monitoring purpose where in the first and the last measurement resources are with X consecutive slots.

Herein, the UE reports its capability on the maximum number of CSI report occasions to be monitored for monitoring outcome reporting. If the UE reports X CSI report occasions as its capability report, the UE is not expected to calculate the monitoring outcome report by averaging over more than X CSI reporting occasions.

Herein, the UE reports its capability on the maximum number of CSI reports for monitoring purposes that can be simultaneously computed. The capability report may be reported in terms of CSI processing units and could be shared to determine the number of simultaneously processed candidate CSI report configurations for monitoring and other purposes.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a communication system, the method comprising:
receiving, from a base station via higher layer signaling, a configuration for a channel state information (CSI) report;
receiving, from the base station, a monitoring measurement resource;
generating the CSI report based on the monitoring measurement resource; and
transmitting, to the base station, the CSI report including a monitoring outcome report.

2. The method of claim 1, further comprising:
transmitting, to the base station, a request for a grant of the monitoring measurement resource;
receiving, from the base station, the monitoring measurement resource as the grant of the request.

3. The method of claim 1, wherein the configuration includes information for a performance measurement metric, and
wherein the CSI report for monitoring is transmitted in response to a condition associated with the performance measurement metric is satisfied.

4. The method of claim 1, wherein:
the CSI report includes an indication indicating a presence or an absence of the monitoring outcome report, and
the CSI report includes the monitoring outcome report based on the indication indicating the presence of the monitoring outcome report.

5. The method of claim 1, further comprising transmitting, to the base station, capability information,
wherein the capability information includes at least one of:
maximum number of monitoring measurement resources, maximum number of ports per monitoring measurement resource or total number of ports across the monitoring measurement resources,
maximum duration for measurement for the monitoring measurement resources,
maximum number of CSI report occasions to be monitored for monitoring outcome reporting, or
maximum number of CSI reports for monitoring purposes that can be simultaneously computed.

6. A method performed by a base station in a communication system, the method comprising:
transmitting, to a user equipment (UE) via higher layer signaling, a configuration for a channel state information (CSI) report;
transmitting, to the UE, the monitoring measurement resource as the grant of the request.

7. The method of claim 6, further comprising:
receiving, from the UE, a request for a grant of the monitoring measurement resource;
transmitting, to the UE, a grant for the request,
wherein the transmission of the monitoring measurement resource and the reception of the CSI report for monitoring is based on the grant for the request.

8. The method of claim 6, wherein the configuration includes information for a performance measurement metric, and
wherein the CSI report for monitoring is transmitted in response to a condition associated with the performance measurement metric is satisfied.

9. The method of claim 6, wherein:
the CSI report includes an indication indicating a presence or an absence of the monitoring outcome report, and
the CSI report includes the monitoring outcome report based on the indication indicating the presence of the monitoring outcome report.

10. The method of claim 6, further comprising transmitting, to the base station, capability information,
wherein the capability information includes at least one of:
maximum number of monitoring measurement resources, maximum number of ports per monitoring measurement resource or total number of ports across the monitoring measurement resources,
maximum duration for measurement for the monitoring measurement resources,
maximum number of CSI report occasions to be monitored for monitoring outcome reporting, or
maximum number of CSI reports for monitoring purposes that can be simultaneously computed.

11. A user equipment (UE) in a communication system, the UE comprising:
a transceiver; and
at least one processor configured to:
receive, from a base station via higher layer signaling, a configuration for a channel state information (CSI) report;
receive, from the base station, a monitoring measurement resource;
generate the CSI report based on the monitoring measurement resource; and
transmit, to the base station, the CSI report including a monitoring outcome report.

12. The UE of claim 11, wherein the at least one processor is further configured to:
transmit, to the base station, a request for a grant of the monitoring measurement resource;
receive, from the base station, the monitoring measurement resource as the grant of the request.

13. The UE of claim 11, wherein the configuration includes information for a performance measurement metric, and
wherein the CSI report for monitoring is transmitted in response to a condition associated with the performance measurement metric is satisfied.

14. The UE of claim 11, wherein:
the CSI report includes an indication indicating a presence or an absence of the monitoring outcome report, and
the CSI report includes the monitoring outcome report based on the indication indicating the presence of the monitoring outcome report.

15. The UE of claim 11, further comprising transmitting, to the base station, capability information,
wherein the capability information includes at least one of:
maximum number of monitoring measurement resources, maximum number of ports per monitoring measurement resource or total number of ports across the monitoring measurement resources,
maximum duration for measurement for the monitoring measurement resources,
maximum number of CSI report occasions to be monitored for monitoring outcome reporting, or
maximum number of CSI reports for monitoring purposes that can be simultaneously computed.

16. A base station in a communication system, the base station comprising:
a transceiver; and
at least one processor configured to:
transmit, to a user equipment (UE) via higher layer signaling, a configuration for a channel state information (CSI) report;
transmit, to the UE, a monitoring measurement resource;
receive, from the UE, the CSI report including a monitoring outcome report based on the monitoring measurement resource.

17. The base station of claim 16, wherein the at least one processor is further configured to:
receive, from the UE, a request for a grant of the monitoring measurement resource;
transmit, to the UE, the monitoring measurement resource as the grant of the request.

18. The base station of claim 16, wherein the configuration includes information for a performance measurement metric, and
wherein the CSI report for monitoring is transmitted in response to a condition associated with the performance measurement metric is satisfied.

19. The base station of claim 16, wherein:
the CSI report includes an indication indicating a presence or an absence of the monitoring outcome report, and
the CSI report includes the monitoring outcome report based on the indication indicating the presence of the monitoring outcome report.

20. The base station of claim 16, further comprising transmitting, to the base station, capability information,
wherein the capability information includes at least one of:
maximum number of monitoring measurement resources, maximum number of ports per monitoring measurement resource or total number of ports across the monitoring measurement resources,
maximum duration for measurement for the monitoring measurement resources,
maximum number of CSI report occasions to be monitored for monitoring outcome reporting, or
maximum number of CSI reports for monitoring purposes that can be simultaneously computed.
